(19) United States
(12) Patent Application Publication
(10) Pub. No.: US 2020/0250304 A1
(43) Pub. Date: Aug. 6, 2020

(54) DETECTING ADVERSARIAL EXAMPLES

(71) Applicant: NEC Laboratories America, Inc., Princeton, NJ (US)

(72) Inventors: Erik Kruus, Hillsborough, NJ (US); Renqiang Min, Princeton, NJ (US); Yao Li, Woodland, CA (US)

(21) Appl. No.: 16/778,213

(22) Filed: Jan. 31, 2020

Related U.S. Application Data
(60) Provisional application No. 62/799,788, filed on Feb. 1, 2019.

(51) Int. Cl. G06F 21/55; G06N 3/08; G06N 3/04

(52) U.S. Cl. CPC G06F 21/55; G06F 2221/031; G06N 3/04; G06N 3/08

(57) ABSTRACT

Systems and methods for detecting adversarial examples are provided. The method includes generating encoder direct output by projecting, via an encoder, input data items to a low-dimensional embedding vector of reduced dimensionality with respect to the one or more input data items to form a low-dimensional embedding space. The method includes regularizing the low-dimensional embedding space via a training procedure such that the input data items produce embedding space vectors whose global distribution is expected to follow a simple prior distribution. The method also includes identifying whether each of the input data items is an adversarial or unnatural input. The method further includes classifying, during the training procedure, those input data items which have not been identified as adversarial or unnatural into one of multiple classes.

### RELATED APPLICATION INFORMATION

This application claims priority to U.S. Provisional Patent Application No. 62/799,788, filed on Feb. 1, 2019, incorporated herein by reference in its entirety.

### BACKGROUND

### Technical Field

The present invention relates to deep learning and more particularly to applying deep learning for detecting adversarial examples.

### Description of the Related Art

Deep learning is a machine learning method based on artificial neural networks. Deep learning architectures can be applied to fields including computer vision, speech recognition, natural language processing, audio recognition, social network filtering, machine translation, bioinformatics, drug design, medical image analysis, material inspection and board game programs, etc. Deep learning can be supervised, semi-supervised or unsupervised.

### SUMMARY

According to an aspect of the present invention, a method is provided for detecting adversarial examples. The method includes generating encoder direct output by projecting, via an encoder, input data items to a low-dimensional embedding vector of reduced dimensionality with respect to the one or more input data items to form a low-dimensional embedding space. The method includes regularizing the low-dimensional embedding space via a training procedure such that the input data items produce embedding space vectors whose global distribution is expected to follow a simple prior distribution. The method also includes identifying whether each of the input data items is an adversarial or unnatural input. The method further includes classifying, during the training procedure, those input data items which have not been identified as adversarial or unnatural into one of multiple classes.

According to another aspect of the present invention, a system is provided for detecting adversarial examples. The system includes a processor device operatively coupled to a memory device, the processor device being configured to generate encoder direct output by projecting, via an encoder, input data items to a low-dimensional embedding vector of reduced dimensionality with respect to the one or more input data items to form a low-dimensional embedding space. The processor device regularizes the low-dimensional embedding space via a training procedure such that the input data items produce embedding space vectors whose global distribution is expected to follow a simple prior distribution. The processor device also identifies whether each of the input data items is an adversarial or unnatural input. The processor device classifies, during the training procedure, those input data items which have not been identified as adversarial or unnatural into one of multiple classes.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a generalized diagram of a neural network, in accordance with an embodiment of the present invention;

FIG. 2 is a diagram of an artificial neural network (ANN) architecture, in accordance with an embodiment of the present invention;

FIG. 3 is a block diagram illustrating a high-level system for detecting adversarial examples, in accordance with an embodiment of the present invention;

FIG. 4 is a block diagram illustrating components for implementing low-dimension space projection which tends to obey a simple prior distribution, in accordance with an embodiment of the present invention;

FIG. 5 is a block diagram illustrating components of a projection and classification system, in accordance with an embodiment of the present invention;

FIG. 6 is a block diagram illustrating an architecture of a system for forming a combined code by concatenating functions of internal encoder values, used for detecting adversarial examples, in accordance with an embodiment of the present invention; and

FIG. 7 is a flow diagram illustrating a method for detecting adversarial examples, in accordance with an embodiment of the present invention.

### DETAILED DESCRIPTION OF PREFERRED EMBODIMENTS

In accordance with embodiments of the present invention, systems and methods are provided to/for detecting adversarial examples. The system projects the image data onto a regularized low-dimensional space to remove the adversarial perturbations from the resultant manifold by minimizing the optimal transport cost between the feature distribution, possibly at different levels of abstraction, and a smooth prior distribution. After projecting the images to low-dimensional space, the system detects examples that are off the learned manifold. For example, the system can be implemented in self-driving cars to detect road signs that have been adversarially modified. The invention also applies to inputs that include other types of unnatural inputs, that cannot be identified with any class label, such as random noise, or inputs of some class absent from the training data, and for brevity we may use only one of the terms “unnatural” or “adversarial”.

In one embodiment, the system retains important features for adversarial example detection in the low-dimensional embedding space while the effect of adversarial perturbations is largely reduced through the projection. The system determines a smooth manifold by projecting to the low-dimensional space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

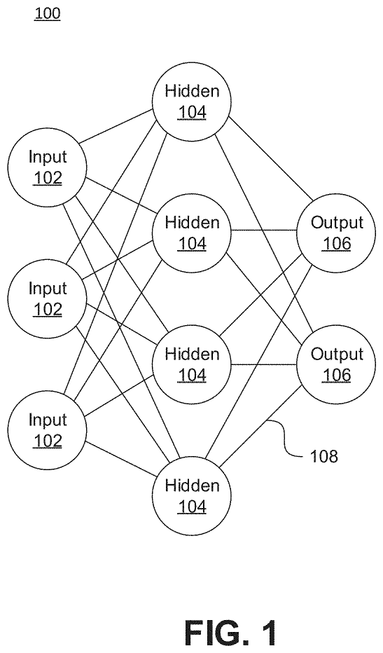

Referring now to the drawings in which like numerals represent the same or similar elements and initially to FIG. 1, a generalized diagram of a neural network that can implement device failure prediction from communication data is shown, according to an example embodiment.

An artificial neural network (ANN) is an information processing system that is inspired by biological nervous systems, such as the brain. The key element of ANNs is the structure of the information processing system, which includes many highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network generally has input neurons 102 that provide information to one or more “hidden” neurons 104. Connections 108 between the input neurons 102 and hidden neurons 104 are weighted and these weighted inputs are then processed by the hidden neurons 104 according to some function in the hidden neurons 104, with weighted connections 108 between the layers. There can be any number of layers of hidden neurons 104, and as well as neurons that perform different functions. There exist different neural network structures as well, such as convolutional neural network, maxout network, perceptron, etc. Finally, a set of output neurons 106 accepts and processes weighted input from the last set of hidden neurons 104. ANNs with forward connections between many sequential layers are known as deep neural networks.

This represents a “feed-forward” computation, where information propagates from input neurons 102 to the output neurons 106. The training data can include input data into a 3D image format. The example embodiments of the ANN can be used to implement an adversarial example detecting system that first projects the images to low-dimensional space (forming a smooth manifold), then detects examples that are off the learned manifold. Adversarial examples are inputs to machine learning models that an attacker has intentionally designed to cause the model to make a mistake. The adversarial examples can be analogized as optical illusions for machines. Manifolds are occupied subspaces, and as described herein a smooth manifold refers to, for example, to a smooth shape of a subspace of the low-D space. For example, a manifold could describe a subspace where the density of natural images is higher than some threshold. In this context the manifold is the “shape” of some probability distribution. By way of a simple example, the subspace can “look like” a line, or a curved sheet of 2 (or more) dimensions embedded withing the low-D space. In example embodiments, around each projected natural image, the density of nearby natural images is not isotropic. Certain directions are “preferred”, and the manifold has a lower “local dimension”. For example, a curved 2-D sheet embedded in the low-D space has a local dimension near 2 at all points far from the edge of the sheet, and points off this curved 2-D sheet may be identifiable as “not on the manifold” or “unnatural”. The average local dimension is the “effective dimension” of the dataset. The ANNs can be trained in the example embodiments to recognize the adversarial examples and thus thwart malicious input to a system that would otherwise result in unwanted results, such as misrecognition and misclassification of images, inaccurate training of systems, etc.

Upon completion of a feed-forward computation, the output is compared to a desired output available from training data. The error relative to the training data is then processed in “feed-back” computation, where the hidden neurons 104 and input neurons 102 receive information regarding the error propagating backward from the output] neurons 106. Once the backward error propagation has been completed, weight updates are performed, with the weighted connections 108 being updated to account for the received error. Repeating this forward computation and backward error propagation procedure with different inputs provides one way to implement a training procedure to train the weights of the ANN. FIG. 1 represents just one variety of ANN.

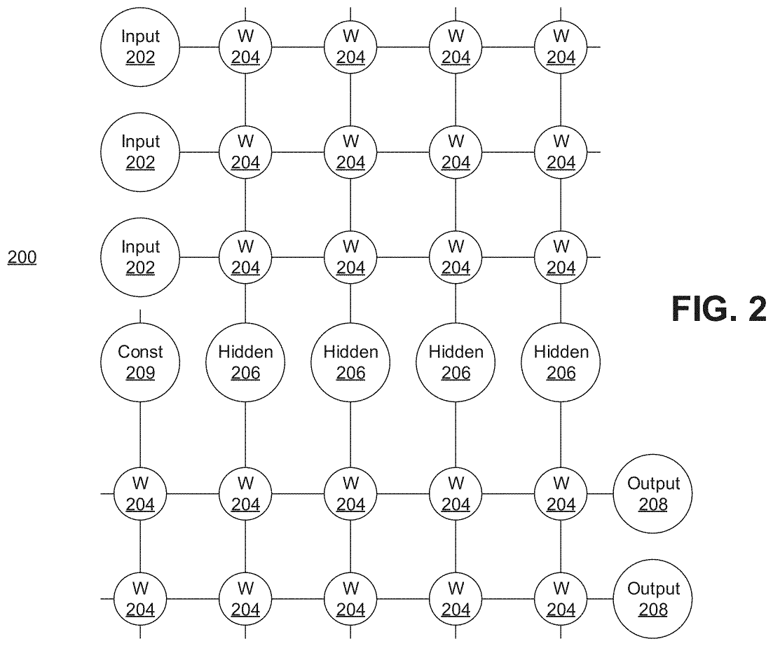

Referring now to FIG. 2, an artificial neural network (ANN) architecture 200 is shown. It should be understood that the present architecture is purely exemplary and that other architectures or types of neural network may be used instead. The ANN embodiment described herein is included with the intent of illustrating general principles of neural network computation at a high level of generality and should not be construed as limiting in any way. FIG. 2 typifies an ANN often known as a recurrent neural network.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 202 each provide an input signal in parallel to a respective row of weights 204. In the hardware embodiment described herein, the weights 204 each have a respective settable value, such that a weight output passes from the weight 204 to a respective hidden neuron 206 to represent the weighted input to the hidden neuron 206. In software embodiments, the weights 204 may simply be represented as coefficient values that are multiplied against the relevant signals. The signals from each weight adds column-wise and flows to a hidden neuron 206.

The hidden neurons 206 use the signals from the array of weights 204 to perform some calculation. The hidden neurons 206 then output a signal of their own to another array of weights 204. This array performs in the same way, with a column of weights 204 receiving a signal from their respective hidden neuron 206 to produce a weighted signal output that adds row-wise and is provided to the output neuron 208.

It should be understood that any number of these stages may be implemented, by interposing additional layers of arrays and hidden neurons 206. It should also be noted that some neurons may be constant neurons 209, which provide a constant output to the array. The constant neurons 209 can be present among the input neurons 202 and/or hidden neurons 206 and are only used during feed-forward operation.

During back propagation, the output neurons 208 provide a signal back across the array of weights 204. The output layer compares the generated network response to training data and computes an error. The error signal can be made proportional to the error value. In this example, a row of weights 204 receives a signal from a respective output neuron 208 in parallel and produces an output which adds column-wise to provide an input to hidden neurons 206. The hidden neurons 206 combine the weighted feedback signal with a derivative of its feed-forward calculation and stores an error value before outputting a feedback signal to its respective column of weights 204. This back-propagation travels through the entire network 200 until all hidden neurons 206 and the input neurons 202 have stored an error value.

During weight updates, the stored error values are used to update the settable values of the weights 204. In this manner the weights 204 can be trained to adapt the neural network 200 to errors in its processing. It should be noted that the three modes of operation, feed forward, back propagation, and weight update, do not overlap with one another.

A deep neural network (DNN) is a subclass of ANNs 100 which generates different levels of feature abstractions by passing through several layers. DNNs have capability of representation learning and can perform perceptual tasks. The DNNs can be implemented for various perceptual tasks, such as image classification, machine translation and speech recognition. However, perceptual systems of humans vary from DNNs significantly. Small but carefully crafted perturbations of images can arbitrarily change the network's prediction with high confidence. However, for humans these perturbations are often visually imperceptible and do not affect human recognition. These small perturbations can be defined as adversarial examples.

The example embodiments protect DNNs against adversarial examples (against which the DNNs can be otherwise vulnerable) which are carefully crafted to mislead the system, while being indistinguishable from the legitimate images to human. The example embodiments herein unify different factors to improve the robustness and stabilization of the performance in adversarial example detection. For example, DNNs generate different levels of feature abstractions by passing through several convolutional layers. Ensembles of these abstractions can be used to help the detector make full use of the cues from all feature locations. Additionally, many high-dimensional datasets, images for example, have a smaller intrinsic dimension than their pixel space dimension. Adversarial input perturbations can be identified as lying near the edge (or completely off) of the manifold of these high-dimensional datasets, in particularly nefarious direction that results in a misclassification or other erroneous prediction. The example embodiments project the (for example, image) data onto a regularized low-dimensional space to remove the adversarial perturbations from the resultant manifold by minimizing the optimal transport cost between the feature distribution with different levels of abstractions and the distribution of the detector outputs.

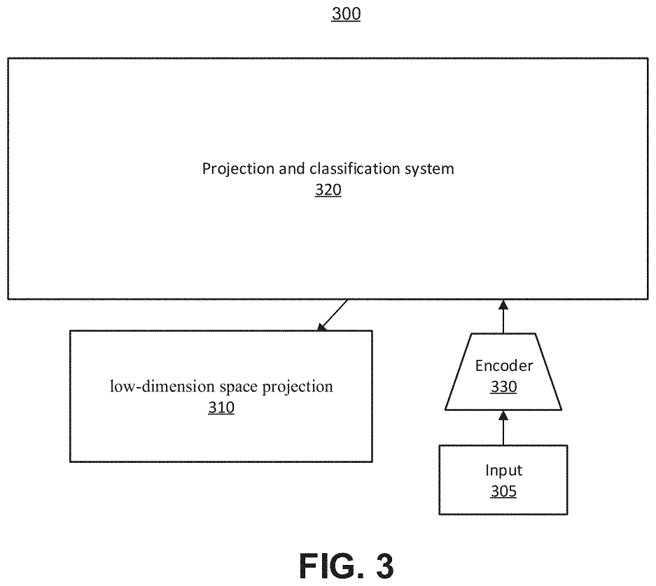

Referring now to FIG. 3, a block diagram 300 illustrating a high-level system for detecting adversarial examples, in accordance with example embodiments.

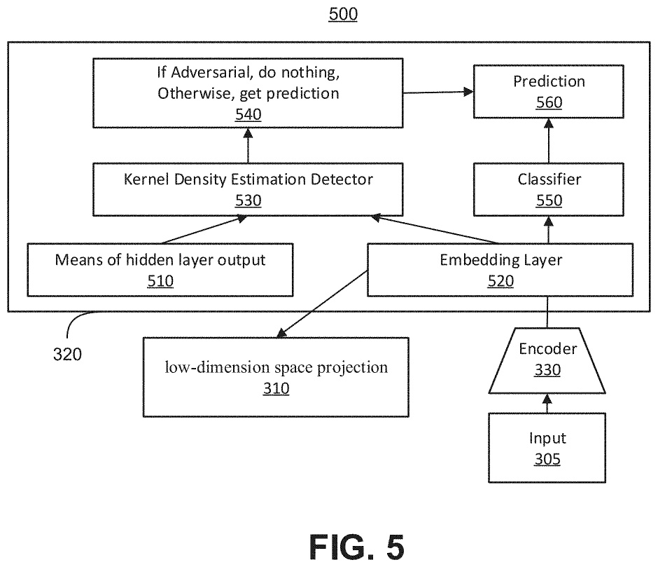

As shown in FIG. 3, the system 300 implements an end-to-end adversarial example detector in which input images 305 are first projected to a low-dimensional space 310 which follows a given prior distribution, and a density-based detection module is implemented based on the resultant latent embedding (for example, as described herein below with respect to projection and classification system 320 and FIG. 5 herein below). Input data 305 can be images of different classes. The input data can be sampled from a possibly uncountable global set of input data items, referred to as all data items or a global set. Input data can include text, chemometric features, etc. The system 300 receives input data 305 at an encoder 330. Inputs may be of different classes. For example, the images input data can be identified in classes such as a stop sign, speed limit, yield sign, traffic light, car, pedestrian, etc. The classes can also include animals (dog, cat, lion, etc.), emotional states (happy, sad, angry, sleepy, etc.), persons (for example, particular named persons), etc.

One of the outputs of projection and classification system 320 is a low-D projection, whose distribution over all natural data is encouraged in low-dimensional space 310 to follow a prior distribution. Note that all items does not refer to all items in the one or more input data items commonly known as a minibatch, but all items in some fuller set of “all input data”. This is a “global” set of inputs over which expectations are formed, such as may occur within loss functions whose errors are backpropagated before updating ANN weights during a training procedure. The low-D projection of projection and classification system 320 is also used to classify the image as “natural” or “unnatural”. A further output of an actual class label can also occur in projection and classification system 320 based on encoder output, and such output must occur during the training procedure to calculate a component of an objective function. The classifier's label is used by the system during training. However, in example embodiments, the system can generate a final output during inference without using (or even evaluating) the classifier's label. The final output during inference on one input in this instance is solely a discriminator output (natural vs unnatural). In this case, once classified as non-adversarial, attachment of a class label can be a separate procedure (even making use of raw input 305 again).

Encoder 330 can implement a parameterized function mapping inputs (for example, images) to an embedding layer. For example, the encoder 330 outputs (maps) the encoded images to projection and classification system 320. The encoder 330 may be a deep neural network (DNN). The projection and classification system 320 outputs to low-dimension space projection 310.

The system 300 can implement Wasserstein distance (aka “optimal transport” or “earth-mover” or Kantorovich's distance) to force the latent space distribution of all example data (310, without regard to class label) to globally lie on a prior distribution. Wasserstein metric provides a good convergence property even when the supports of two probability measures have little intersection. Kantorovich's distance induced by the optimal transport problem is given by

$${W}_{c} ( {P}_{Y} , {P}_{C} ) := {inf}_{Γ ∈ 𝒫 ( Y ∼ {P}_{Y} , U ∼ {P}_{C} )} {𝔼}_{( Y , U ) ∼ Γ} \{ c ( Y , U ) \} ,$$

where Γ∈P(Y˜P_{Y}, U˜P_{C}) is the set of all joint distributions of (Y,U) with marginals P_{Y} and P_{C}, and c(y,u):U×U [symbol] [symbol] ₊ is any measurable cost function. W_{c}(P_{Y}, P_{C}) measures the divergence between probability distributions P_{Y} and P_{C}. The system 300 can support a generative model of the target data distribution based on minimizing the Wasserstein distance, which encourages the encoded training distribution to match the prior. Optimal transport can also be used to boost the performance of generative adversarial networks.

The prior distribution can be a normal Gaussian distribution. The system thereby implements features of regularized deep embedding. The system 300 minimizes optimal transport cost between the feature distribution with different levels of abstractions, and the distribution of the detector outputs. The training procedure guides the system 300 to learn more distinguishable representations on filtering adversarial examples. For example, the procedure can be implemented once, executes multiple times over multiple sets of one or more input data items during training, and is available to be executed during inference time for each set of one or more input data items, and its output allows one to predict a class label for each of the one or more input data items.

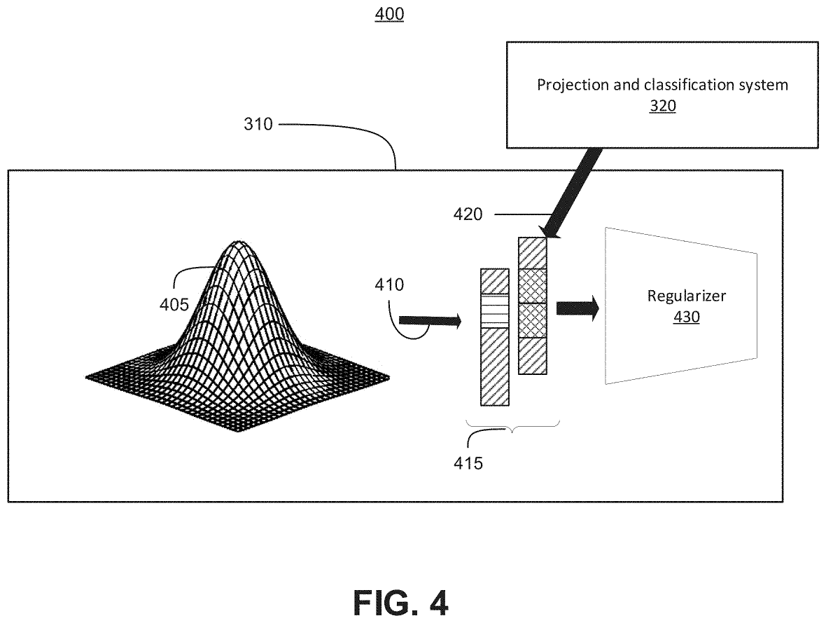

The system 300 can incorporate different levels of feature abstractions (for example, in a complementary manner) to convolutions into the deep embedding learning, which provides more meaningful information to characterize the data manifold, and thus enhances the adversarial example detection performance, as described herein below from FIG. 4 to FIG. 7. The system 300 determines a model that maps from input space (for example, a set of natural images) to reduced dimensional embedding space. This is the encoder (parameters describing a neural network, etc., as described herein below). The model output can also include the hidden layer output means, as one way to incorporate information from different levels of feature abstraction in a DNN.

FIG. 4 is a block diagram 400 illustrating components for a method of implementing a low-dimension space projection 310 which tends to obey a simple prior distribution, in accordance with example embodiments. FIG. 4 is applied during a training procedure, and may be skipped during inference.

The system can receive labeled input data for a training procedure, which optimizes classifier (as described with respect to FIG. 5) and regularizer 430 parameters. Low-dimension space projection 310 projects input images 305 (not shown in FIG. 4) to a low-dimensional space which follows a given prior distribution 405. The prior distribution can be a normal Gaussian distribution. A random sample 410 may be drawn from the simple prior distribution. The low-dimension space projection 310 also receives data 420 from the embedding layer of the projection and classification system 320. The low-dimension space projection 310 provides both actual data 420 and randomly sampled data 405 as features 415. Features 415 are supplied to a regularizer 430 which tries to discriminate between actual data and the random samples.

Regularizer 430 outputs a loss term comparing input data with samplings from a smooth prior. One of the training objectives is to make the global input data distribution of input data samples 420 as indistinguishable as possible, as determined by regularizer 430, from samples from smooth prior distribution 405. It may be recognized that a regularizer operating in this manner is performing the role of a discriminator, however, we call it a regularizer to distinguish it from the discrimination of natural versus unnatural inputs that occurs within the Projection and Classification system 320. Adversarial images, which often look unaltered to humans can be crafted to fool machine learning classifiers into making incorrect predictions. Adversarial or unnatural images within inputs 420 may typically be ignored. Data augmentation procedures can be used to augment the set of natural images, such as limited amounts of translation, rotation, shear, random noise, or color space modification, etc. Such lightly modified (nonadversarial) input data will often be provided as inputs 420 and also encouraged to follow simple prior distribution 405 during such data augmentation.

FIG. 5 is a block diagram 500 illustrating components of projection and classification system 320, in accordance with example embodiments.

As shown in FIG. 5, projection and classification system 320 includes components for implementing means of hidden layer output 510, embedding layer 520, kernel density estimation detector 530, if adversarial, do nothing, otherwise, get prediction 540, classifier 550, and prediction 560.

Means of hidden layer output 510 is an optional method to add one or more dimensions to the low-dimension space projection to detect unnatural images. Unnatural images in some instances may have different average value in certain layers of a DNN, so in some cases the difference in average value can be used to help detect adversarial images. In some instances, a similar expanded version of the embedding layer 520 output may also be useful inputs to the classifier 550, or low-dimension space projection 310

Embedding layer 520 outputs vectors (in “latent space” or “embedding space”) of reduced dimensionality with respect to input dimension of 305. For purposes of this invention the number of reduced dimensions of this low-dimensional embedding space may be understood to be less than or equal to 512. This value is appropriate because for many problems the intrinsic dimension of the data is often below one hundred. In another example, the reduced dimensionality of the low-dimensional embedding vector ≤1024. Dimensions in this context refers to a count of how many variables are used to describe something. For example, a black and white input image with 200×200 pixels has input dimension 40000. A 200×200 color RGB input has input dimension 200*200*3=120000. According to example embodiments, the latent space can be bound to <1000 dimensions. In other examples, a nonlinear dimensionality reduction method such as ISOMAP face data intrinsic dimension can be estimated to be around 3.5, while Modified National Institute of Standards and Technology (MNIST) intrinsic dimension is approximately 13 (as shown in FIG. 4) so that for these datasets projection to 16 or 32 embedding dimensions can provide an ability to detect adversarial versus natural images. For example, the dimension of the embedding layer 520 can be determined to be a multiple (for example, a few times) of the intrinsic dimension of the input data. In some instances, the system does not make a distinction between encoder and embedding layer. For example, the system can identify the output of convolutional layers of a neural network with the encoder 520 and the final linear layers as the embedding layer (520). In some implementations, for expedience, the system can forego producing an internal output from 330 and treat 330 and 520 as single system block.

According to an example embodiment, kernel density estimation detector 530 (the discriminator) has a Boolean output describing acceptable vs unacceptable image. If acceptable 540, during inference, then modules 550 and 560 can optionally provide a second output being a class label. There must be more than one class label possible. During training, however, 550 and 560 will typically always be run, since their output is required to evaluate the classification loss term, such as described below with respect to training the projection and classification system process.

Note that the kernel density estimation can be implemented when all inputs are known to be “good or close enough to good”. For example, adversarial training, while providing a more accurate (or preferable) result, is not an absolute necessity. As in FIG. 3, data augmentation procedures may be used to augment the set of “natural” inputs which kernel density estimation detector 530 detects to be “acceptable” images. Likewise, the input stream may be supplemented with adversarial or unnatural inputs during training which kernel density estimation detector 530 is to identify as unacceptable (/adversarial/unnatural), and in which case module 530 may alternatively be implemented as an ANN. In this case, kernel density estimation detector 530 may be implemented as a parameterized discriminator between natural and unnatural images, and fulfills a similar function as typical in generative adversarial networks (GANs).

If adversarial, do nothing, otherwise, get prediction (module) 540 determines whether the example is adversarial. If the example is adversarial, module 540 does nothing. If the example is not adversarial, module 540 gets a prediction from prediction (module) 560. The prediction module 560 can be implemented by a separate neural network 550 whose output dimensionality is equal to the number of class labels and where the dimension with maximal value is identified with a particular class label within module 560. Alternatively, relative values in each output dimension of classifier 550 can be used to rank the probability of an input being in different classes and form predictor 560 output.

Classifier 550 can include a parameterized classifier followed by a predictor (prediction 560) whose output is a class label, and a classification loss promoting correct label predictions. During training of system 500, C(Z) is the output of running classifier 550, which is compared with the true label g(X). The [symbol] (g(X), C(Z)) term of the objective function promotes agreement between the predicted class (as output from 560) and the actual class label g(X) of the training data.

The labeled input dataset of non-adversarial data can be augmented by adversarial examples from an adversarial attack method. Attack methods have been identified that (attempt to) evade defense models by generating adversarial examples, which are visually indistinguishable from the corresponding legitimate ones but can mislead the target DNNs. The system 300 can protect against attack methods under white box setting, which are harder to defend against and detect. Under white box setting, the adversarial entity can analytically compute the model's gradients/parameters and have full access to the model architecture. White-box attacks can generate adversarial examples based on the gradient of loss function with respect to the input. The system 300 can implement robust machine learning models against attacks, such as Fast Gradient Sign Method (FGSM), Carlini and Wagner (C&W) and Projected Gradient Descent (PGD) attacks.

FGSM generates adversarial examples based on the sign of gradients, which crafts an adversarial example x* as x*=x₀−ϵ·sign(∇ₓL(w, x₀)), with the perturbation E, network weights w and the training loss L(w, x₀). C&W attack formulates the adversarial example generating process as an optimization problem. The proposed objective function aims at increasing the probability of the target class and minimizing the distance between the adversarial example and the original input image. PGD attack finds adversarial examples in an ϵ-ball of the image. PGD attack updates with the direction that decreases the probability of the original class most, then projects the result back to the ϵ-ball of the input. For example, the example embodiments can defend against l_{∞}-PGD untargeted attack under white-box setting.

The example embodiments can use a training method (for example, stochastic gradient descent methods) to minimize an objective function. The objective function is a scalar number that can be a weighted sum representing how well different desirables are obtained. For example, training method for this invention can have an objective function which estimates compliance with 3 goals: 1) low-dimensional embedding globally follows a simple prior (310); 2) discriminator correctly predicts natural vs. adversarial input image (530); 3) class labels of natural images are correctly predicted (560). The system 300 can be trained to find encoder, classifier and kernel density estimator parameters that minimizing a weighted sum of corresponding losses of: the regularizer (430), the parameterized classifier (550) and the parameterized discriminator (530) that identifies natural (vs. adversarial or unnatural) inputs.

Training can yield latent space embeddings where natural data for each class are widely separated, and for which two-dimensional (2D) visualizations (for example, via t-Distributed Stochastic Neighbor Embedding (tSNE)) can display well-separated curves. These curves represent the “manifold” or “subspace” of the latent space occupied by data.

At training stage, the encoder Qϕ (330) first maps the input x∈X to a low dimensional space, resulting in direct output (z∈Z′) and/or combined code (z∈Z^{˜}). Another ideal code (Z) is sampled from the prior distribution P_{Z}, and the regularizer Dγ (430) discriminates between the ideal code Z and the generated combined code z. The classifier (Cτ) predicts the image label based on the encoder output (z∈Z^{˜} or Z′). Details of training the projection and classification parts are shown below.

Training the projection and classification system process:

1: Input: Regularization coefficient λ>0, and initialized encoder Qϕ, discriminator Dγ, and classifier Cτ.

2: Note: [symbol] stands for the classification loss, and is often calculated using the cross-entropy loss.

3. while (ϕ,γ,τ) not converged do

4. Sample {(x1,y1), . . . , (xn,yn)} from the training set

5. Sample {z1, . . . , zn} from the prior P_{Z}

6. Sample z^{˜}i from Qϕ (Z|xi) for i=1, . . . , n

7. Update Dγ by ascending the following objective by 1-step Adam:

Update Qϕ and Cτ by descending the following objective by 1-step Adam:

Update Qϕ by ascending the following objective by 1-step Adam:

end while.

For simplicity of training, the system 300 can apply standard Gaussian as the prior distribution P_{Z}. The objective function of training the Projection and Classification System can be summarized as:

$${inf}_{Q ( Z \vert X ) ∈ Q} {𝔼}_{{P}_{X}} {𝔼}_{Q ( Z \vert X )} [ 𝓁 ( g ( X ) , C ( Z ) ) ] + λ 𝒟 ( {Q}_{Z} , {P}_{Z} ) ,$$

where Q is any non-parametric set of probabilistic encoders, λ>0 is a hyper-parameter and D is an arbitrary divergence between Q_{Z} and P_{Z}. To estimate the divergence D(Q_{Z},P_{Z}) between Q_{Z} and P_{Z}, the system 300 applies a GAN-based framework, fitting a discriminator to minimize the 1-Wasserstein distance between Q_{Z} and P_{Z}. This discriminator we call the “regularizer”, to distinguish it from the discriminator that identifies inputs as natural vs unnatural/adversarial. This invention must use an objective function incorporating at least a classification loss and a regularization loss. Additional loss terms may be present during training to determine parameters for module 530, especially if the training input contains instances of both natural and unnatural/adversarial nature. In the preferred embodiment, we do craft adversarial examples based on current classifier parameters throughout the training process, because adversarial examples will evolve as the classifier parameters are changed. In this case, we prefer to implement module 530 using an ANN, as often done in GANs. For example, we may augment each minibatch of natural or data augmentation inputs with on-demand adversarial inputs. Optionally we may include unnatural inputs of various types to further train module 530.

Assume there is an oracle g:χ [symbol] [symbol] assigning the image data (x∈X) its true label (y∈U). The oracle refers to the known true label at the time the image was generated, or a human-assigned label. The oracle is used during training for the classification loss terms [symbol] (g(x), C(z)). The system 500 can optimize over an objective function and thereby minimize the discrepancy between the true label distribution (P_{Y}) and the output distribution P_{C} such that input examples are classified correctly. According to an example embodiment, the classifier 550 can consist of 3 linear layers whose output dimension is the number of classes and a loss function [symbol] (g(x), C(z)) can be the root mean square (rms) distance between classifier output and a one-hot encoding of the true label, g(X).

The system 300 can distinguish the embeddings of adversarial inputs that do not occupy the same space as the embeddings of original (and optional randomly perturbed) data. For example, the system 300 can differentiate (for example, by application of visual or other processes) regions of latent space that have low adversarial density from others have high adversarial density to detect adversarial examples. The extent of the manifold of normal (for example, randomly perturbed) input is characterized such as to distinguish adversarial from non-adversarial inputs.

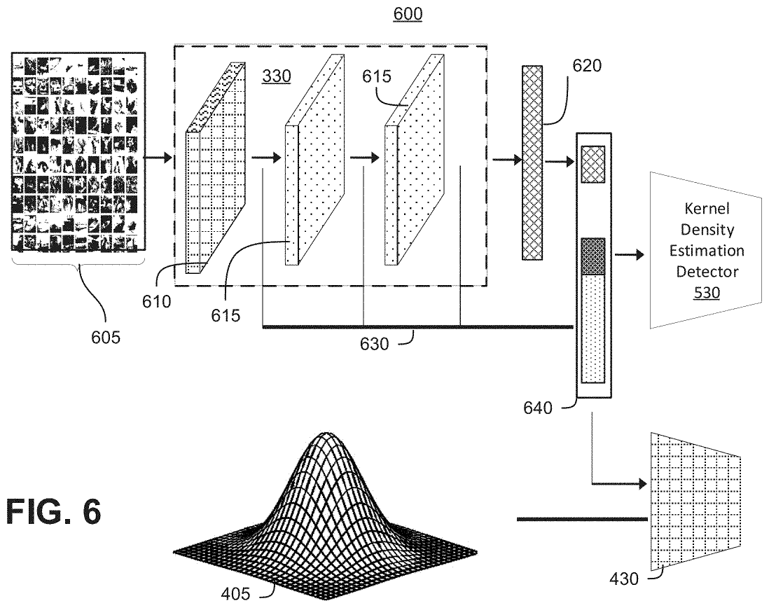

According to an example embodiment, the system 300 can detect adversarial examples by finding kernel density estimation (KDE) scores for each class and performing a logistic regression model to separate the combined KDE scores of adversarial from non-adversarial examples. Embedding may be extended to include summary statistics (for example, mean value) of intermediate values calculated within the encoder procedure for example using means of intermediate layers of deep neural network Encoder (for example, through code concatenation in a similar manner as described below with respect to FIG. 6).

According to example embodiments, the system 300 can identify adversarial samples that do not lie on the same manifold as the true data and employ multi-layer feature dependencies complementary to convolutions in improving robustness and stabilization of detectors. The system 300 can implement regularized deep embedding, where input images are embedded into a low-dimensional space with regularizers to enforce the space following a prior distribution, and a density-based detection module based on the learned latent embedding, while retaining the ability to separate inputs of different classes. Regularization is the process of adding information in order to solve an ill-posed problem or to prevent overfitting. Out of many possible optimized descriptions of similar performance, the regularizers can be used to select one that has a “smoother” or “simpler” distribution over typical inputs.

According to example embodiments, the system 300 minimizes a penalized form of Wasserstein distance between the feature distribution with different levels of abstractions, and the distribution of the detector outputs. For example, the encoder can be expressed as a series of sequential transformations, as typified by deep neural networks or recurrent neural networks. Here the outputs of successive encoder layers are associated with increasing levels of abstraction. In example embodiments the regularizations penalize distance from the final “embedding space” distribution to the prior. In further example embodiments, the systems perform optional regularizations to enforce a prior distribution on outputs of selected intermediate outputs of the encoder or projection procedure. The system 300 encapsulates the joint inference in a generative adversarial training process. The system 300 implements a kernel density estimation detector 530 in the latent space that separates natural from unnatural inputs. The low-dimension space projection 310 enforces the embedding space of the model (encoder and projection procedure, embodied by a number of parameters as in a neural network) to follow the prior distribution. The encoder and discriminator structures together diminish the effect of the adversarial perturbation by projecting input data that globally has a manageable shape with a single mode space, then performing density-based detection with the low-dimensional embedding. Natural input data is mapped to subspace of the embedding space that, while globally following a simple prior, can have even lower local dimension and low curvature, as well as separating the various class labels. This is the subspace of embedding space occupied by real data inputs and is identified with nonadversarial inputs within system 500. Single mode space in this context refers to following the simple prior (‘modes’ in this context refers to how many gaussians describe some distribution).

The expectation satisfied during training the regularizer is an expectation over all input data items. Thus, global in this instance refers to all training inputs in all sets of one or more input data items (minibatch) used as inputs to the training procedure. It is not the expectation over the possibly small subset, such as a single minibatch, because the small subset is not necessarily a random sampling. That is, if items in a particular minibatch are all images of a particular person, the system would generate embedding space vector clustered around the particular person, in contrast to being distributed according to some simple prior. The expectation is over a much larger subset of data items encountered during training a presumably much larger set of input data.

According to example embodiments, the system 300 uses l_{∞} and l₂ distortion metrics to measure similarity between 8-bit images. The system 300 reports l_{∞} distance in the normalized [0, 1] space, so that a distortion of 0.031 corresponds to 8/256, and l₂ distance as the total root-mean-square distortion normalized by the total number of pixels.

Images x∈X=R^{d} are projected to a low-dimensional embedding vector z∈Z′/Z^{˜}= [symbol] ^{k} through the encoder Q_{ϕ} (330). Alternatively a combined code z∈Z^{˜}= [symbol] ^{k} may be generated by concatenating the hidden layer output mean and encoder direct output Z′. The discriminator D_{γ} discriminates between the combined code z˜Q_{ϕ}(Z|X) and the ideal code Z˜P_{Z}. The classifier C_{τ} performs classification based on the output from the encoder 330, where the classification can be performed on either direct output z∈Z′ or combined output z∈Z^{˜}. The classifier outputs u∈U= [symbol] ^{m}, where m is the number of classes. The label of training example x∈X is denoted as y∈[0,m−1] Training of the module to identify natural/unnatural inputs may use an additional input data label denoting whether the input is natural x∈X or adversarial/unnatural x∉X with respect to

[symbol]

FIG. 6 is a block diagram 600 illustrating an architecture of an adversarial example detecting system 600, in accordance with example embodiments, which shows an example of how the concatenated code can be used for two purposes

As shown adversarial example detecting system 600 includes input images 605 (for example, x˜Pₓ), convolution layers (conv2D+ReLu (610), conv2D+BatchNorm+ReLu (615)) terminating with fully connected layers (620). Concatenated values 630 may be derived as means of out puts from a predetermined set of layers 610, 615 within the DNN, and added to the usual DNN output 620. Such concatenation is also depicted as the combination of outputs of module 520 and 510 in FIG. 5.

Assume there is an oracle g:χX [symbol] [symbol] assigning the image data (x∈X) its true label (y∈U). The oracle refers to the known true label at the time the image was generated, or a human-assigned label. The oracle is used for the classification loss term during training. The system 600 can optimize over an objective function and thereby minimize the discrepancy between the true label distribution (P_{Y}) and the output distribution P_{C}. According to an example embodiment, the classifier can consist of 3 linear layers whose output dimension is the number of classes and a loss function can be the root mean square (rms) distance between classifier output and a one-hot encoding of the true label, g(X).

According to example embodiments, the system 600 can minimize a penalized form of Wasserstein distance between the feature distribution with different levels of abstractions, and a smooth prior which can be implemented with prior distribution 405 and regularizer 430. The joint inference is encapsulated in a generative adversarial training process, as described with respect to FIG. 5 herein above. The system 600 implements a regularizer 430 in the latent space that compares the concatenated code from the low-dimensional space 620 and the ideal code sampled from standard Gaussian distribution 405. The kernel density estimation detector 530 can identify natural from unnatural/adversarial inputs using the representative power of adversarial training.

According to example embodiments, system 600 implements an end-to-end adversarial example detector where input images are first projected to a low dimensional space which follows a given prior distribution, and a density-based detection module based on the resultant latent embedding. The system 600 minimizes optimal transport cost between the feature distribution with different levels of abstractions, and a smooth prior. The training procedure guides the system 600 to learn more distinguishable representations for filtering adversarial examples.

According to example embodiments, system 600 can incorporate different levels of feature abstractions as a complementary to convolutions into the deep embedding learning, which may provide more meaningful information to characterize the data manifold, thus enhance the adversarial example detection performance.

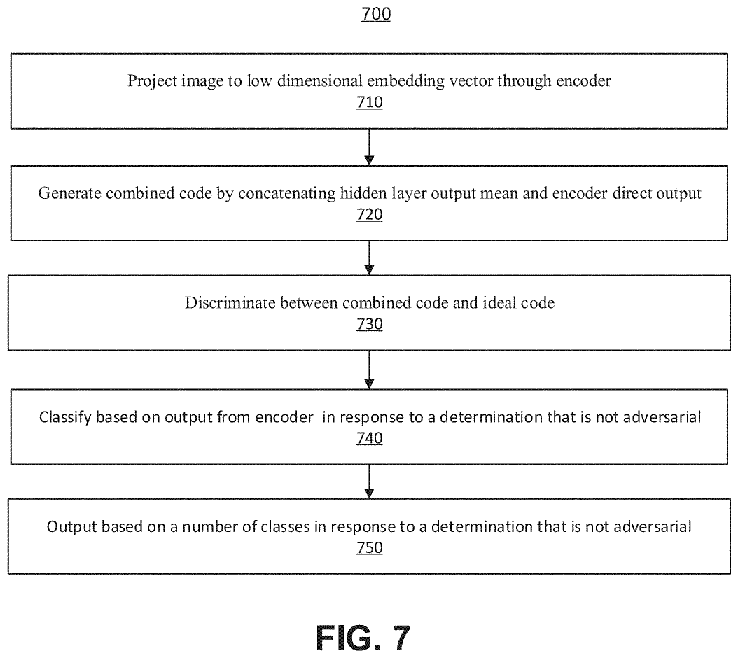

FIG. 7 is a flow diagram illustrating a method 700 for detecting adversarial examples, in accordance with the present invention.

At block 710, system 300 projects images (X∈X=R^{d}) to a low-dimensional embedding vector Z′∈Z=R^{k} through the encoder Q_{ϕ} (330).

At block 720, system 300 generates combined code Z^{˜} by concatenating the hidden layer output mean and encoder direct output Z′. Z^{˜} may be identical to Z′.

At block 730, system 300 discriminates (using the discriminator D_{γ}) between the combined code Z^{˜}˜Q_{ϕ}(Z|X) and the ideal code Z˜P_{Z}. The “ideal code” is used during training to force natural images to globally follow the simple prior as in encoder 330. The kernel density estimation detector 530 is a separate function that outputs a Boolean value (natural image or not).

At block 740, system 300 performs classification (using the classifier C_{τ}) based on the output from the encoder 330, where the classification can be performed on either combined output Z^{˜} or direct output Z′.

At block 750, system 300 outputs (via the classifier) based on a number of classes. For example, U∈U= [symbol] ^{m}, where m is the number of classes. The label of X is denoted as Y∈U. For example, for 10 classes as in MNIST digits, the label Y is a single number from 0 to 9; however, U is a 10-dimensional vector of real numbers. If dimension 0 is the largest real number of the 10-dimensional U, the system 300 can output label prediction Y=0.

According to example embodiments, the classification process is required to be run during training (since the system 300 uses the classification process to calculate its contribution to an objective function), but can optionally run during inference (when presented with new, unlabeled data (for example, “from the wild”, not previously encountered, etc.). In these instances, both regularizing and classifying must use the same training procedure, because the objective function that the system 300 optimizes involves a weighted sum of a regularization loss and a classification loss.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting adversarial examples, comprising:
generating encoder direct output by projecting, via an encoder, one or more input data items to a low-dimensional embedding vector of reduced dimensionality with respect to the one or more input data items to form a low-dimensional embedding space;
regularizing the low-dimensional embedding space via a training procedure such that the one or more input data items produce embedding space vectors whose global distribution is expected to follow a simple prior distribution;
identifying whether each of the one or more input data items is an adversarial or unnatural input; and
classifying, at least during the training procedure, at least those input data items which have not been identified as adversarial or unnatural into one of a plurality of classes.

2. The method as recited in claim 1, where a combined code formed by concatenating the encoder direct output with a vector of output means of predetermined internal parameters of the encoder is used as input for a combination of at least one of the steps of:
regularizing the embedding space by enforcing the combined code to follow a simple prior;
identifying whether a data item is adversarial or unnatural; and
classifying at least those input data items not identified as adversarial or unnatural into one of a plurality of classes.

3. The method as recited in claim 1, wherein the input data items are one or more input data items that are adversarially generated, or unnatural input data that matches none of the plurality of classes, allowing an additional boolean input where one or both of:
unnatural or adversarially generated input data is not included in a training of a regularization procedure, and
an identification of each of the one or more input data items as an adversarial or unnatural input admits a training procedure encouraging that input items known to be unnatural or adversarial are correctly identified.

4. The method as recited in claim 1, further comprising:
minimizing a penalized form of Wasserstein distance to train the encoder to produce embedding space vectors such that the embedding space vectors of a subset of the input data items including all natural and nonadversarial items are expected to follow a simple prior distribution, and
training the encoder to force pre-selected subsets of internal hidden parameters, at different levels of abstraction, to follow other simple distributions.

5. The method as recited in claim 1, wherein the simple prior distribution used for regularization is a multidimensional Gaussian distribution.

6. The method as recited in claim 1, further comprising:
identifying adversarial or unnatural input data items by differentiating regions of embedding space that have low adversarial density from regions of embedding space that have high adversarial density.

7. The method as recited in claim 1, wherein the reduced dimensionality of the low-dimensional embedding vector is selected from one of ≤512 and ≤1024.

8. The method as recited in claim 1, wherein the encoder comprises a parameterized function mapping inputs to an embedding layer.

9. The method as recited in claim 1, wherein classifying the one or more data items further comprises:
applying a parameterized classifier followed by a predictor that has an output of a class label, and a classification loss promoting correct label predictions.

10. The method as recited in claim 1, wherein the one or more input data items further comprises a labeled input dataset of non-adversarial data, augmented by adversarial examples from at least one adversarial attack method.

11. A computer system for detecting adversarial examples, comprising:
a processor device operatively coupled to a memory device, the processor device being configured to:
generate encoder direct output by projecting, via an encoder, one or more input data items to a low-dimensional embedding vector of reduced dimensionality with respect to the one or more input data items, forming a low-dimensional embedding space;
regularize the low-dimensional embedding space via a training procedure such that the one or more input data items produce embedding space vectors whose global distribution is expected to follow a simple prior distribution;
identify whether each of the one or more input data items is an adversarial or unnatural input; and
classify, at least during said training procedure, at least those input data items which have not been identified as adversarial or unnatural into one of a plurality of classes.

12. The system as recited in claim 11, where the processor device is further configured to use a combined code formed by concatenating the encoder direct output with a vector of output means of predetermined internal parameters of the encoder as input for a combination of at least one of the steps of:
regularize the embedding space by enforcing the combined code to follow a simple prior;
identify whether a data item is adversarial or unnatural; and
classify at least those input data items not identified as adversarial or unnatural into one of a plurality of classes.

13. The system as recited in claim 11, wherein the input data items are one or more input data items that are adversarially generated, or unnatural input data that matches none of the plurality of classes, allowing an additional boolean input where one or both of:
unnatural or adversarially generated input data is not included in a training of a regularization procedure, and
an identification of each of the one or more input data items as an adversarial or unnatural input admits a training procedure encouraging that input items known to be unnatural or adversarial are correctly identified.

14. The system as recited in claim 11, wherein the processor device is further configured to:
minimize a penalized form of Wasserstein distance to train the encoder to produce embedding space vectors such that the embedding space vectors of a subset of the input data items including all natural and nonadversarial items are expected to follow a simple prior distribution, and
train the encoder to force pre-selected subsets of internal hidden parameters, at different levels of abstraction, to follow other simple distributions.

15. The system as recited in claim 11, wherein the simple prior distribution used for regularization is a multidimensional Gaussian distribution.

16. The system as recited in claim 11, wherein the processor device is further configured to:
identify adversarial or unnatural input data items by differentiating regions of embedding space that have low adversarial density from regions of embedding space that have high adversarial density.

17. The system as recited in claim 11, wherein the encoder comprises a parameterized function mapping inputs to an embedding layer.

18. The system as recited in claim 11, wherein, when classifying the one or more data items, the processor device is further configured to:
apply a parameterized classifier followed by a predictor that has an output of a class label, and a classification loss promoting correct label predictions.

19. A computer program product for detecting adversarial examples, the computer program product comprising a non-transitory computer readable storage medium having program instructions embodied therewith, the program instructions executable by a computing device to cause the computing device to perform the method comprising:
generating encoder direct output by projecting, via an encoder, one or more input data items to a low-dimensional embedding vector of reduced dimensionality with respect to the one or more input data items to form a low-dimensional embedding space;
regularizing the low-dimensional embedding space via a training procedure such that the one or more input data items produce embedding space vectors whose global distribution is expected to follow a simple prior distribution;
identifying whether each of the one or more input data items is an adversarial or unnatural input; and
classifying, at least during said training procedure, at least those input data items which have not been identified as adversarial or unnatural into one of a plurality of classes.
